(19) United States
(12) Patent Application Publication
(10) Pub. No.: US 2012/0060194 A1
(43) Pub. Date: Mar. 8, 2012

(54) PROGRAMMING-NETWORK CONTROL OF TIME-SHIFT TELEVISION RECORDING

(76) Inventor: James Alexander, Highlands Ranch, CO (US)

(21) Appl. No.: 12/875,298

(22) Filed: Sep. 3, 2010

(51) Int. Cl. H04N 5/445

(52) U.S. Cl. 725/55; 725/58

(57) ABSTRACT

A method and apparatus in a television delivery system for enabling a programming network or other content owner to control recording of television programs by a service provider network. The programming network transmits the television programs to the service provider network, and the service provider network records the television programs for time-shifted delivery to end users. The programming network determines scheduling information for the television programs, creates recording instructions based on the scheduling information, and injects the recording instructions as metadata in a media stream sent to the service provider network. A recording system in the service provider network extracts the metadata from the media stream, and records the television programs in accordance with the received recording instructions. The recording instructions are more accurate and up-to-date than existing Electronic Program Guide (EPG) information. Additional control instructions may also be included in the metadata.

### CROSS-REFERENCE TO RELATED APPLICATIONS

NOT APPLICABLE

### STATEMENT REGARDING FEDERALLY SPONSORED RESEARCH OR DEVELOPMENT

NOT APPLICABLE

### REFERENCE TO SEQUENCE LISTING, A TABLE, OR A COMPUTER PROGRAM LISTING COMPACT DISC APPENDIX

NOT APPLICABLE

### BACKGROUND

The present invention relates to television delivery systems. More particularly, and not by way of limitation, the present invention is directed to a system and method enabling a television programming network, or other content owner, to control time-shift television recording at a service provider network.

Current Time-Shift Television (TSTV) systems have the ability to monitor a linear television program stream and to record specific programs from programming networks such as ABC, NBC, CBS, and the like. Typically in a TSTV system, the recordings are scheduled by the use of a feed from an Electronic Program Guide (EPG), or though a manual scheduling process set up by service provider personnel (i.e., cable or satellite TV operators). The TSTV system then uses the times defined in the EPG or schedule to record programs to files. These files are used to implement time-shift services such as StartOver, Catchup, Pause Live TV, and Video-On-Demand (VOD).

TSTV Systems are operated by service providers such as cable or satellite operators, and are not directly linked with any component of the programming network operations. TSTV Systems may be located in the service provider's head end or other location within the service provider's network. The systems are fully managed by the service provider; and are dependent upon the accuracy of the EPG or schedule information used by the service provider to be effective. This causes several problems. First, the schedule information such as the EPG information may be incorrect, and consequently, recordings may not be correctly recorded. Second, the EPG information may not accurately reflect when programs actually start or end, causing the recording to miss part of the program at the beginning or end. Third, last minute updates to programming by the programming networks cannot be supported. Finally, programming networks have no control over the TSTV recording.

### SUMMARY

The present invention provides an explicit link from the programming network to the service provider's TSTV system to allow exact control of TSTV recording. In one embodiment, a Push TSTV system at the programming network injects metadata into the Broadcast Moving Picture Experts Group (MPEG) media stream at origination. The metadata provides accurate and up-to-date scheduling and other recording information for use by the service provider head end. A TSTV Recording system at the service provider network then uses the metadata to schedule and set up recordings rather than, or in addition to, using the EPG information currently used.

In one embodiment, the present invention is directed to a method of enabling a television programming network to control recording of television programs by a service provider network, wherein the programming network transmits the television programs to the service provider network, and the service provider network records the television programs for time-shifted delivery to end users. The method includes the steps of sending recording instructions from the programming network to the service provider network; and recording the television programs by the service provider network in accordance with the recording instructions.

In another embodiment, the present invention is directed to an apparatus in a television programming network for controlling recording of television programs by at least one service provider network, wherein the programming network transmits the television programs to the service provider network, and the service provider network records the television programs for time-shifted delivery to end users. The apparatus includes a scheduler for determining scheduling information for the television programs; means for creating recording instructions based on the scheduling information; and means for sending the recording instructions from the programming network to the service provider network.

In another embodiment, the invention is directed to an apparatus in a service provider network for recording television programs received from a television programming network, wherein the service provider network records the programs for time-shifted delivery to end users. The apparatus includes means for receiving recording instructions from the television programming network; and means for recording the television programs in accordance with the received recording instructions.

The invention improves TSTV programming in two ways. First, it provides an explicit mechanism to accurately send and receive recording instructions for programs; the information is provided directly by the programming network, so it is accurate and up-to-date. Second, the invention enables programming networks to fully control TSTV recording, or better control recordings based upon agreements with service providers. Programming networks can provide through the metadata, explicit instructions on what can be recorded, editing rules and marks for content, and the rights granted to different service providers.

### BRIEF DESCRIPTION OF THE DRAWINGS

In the following section, the invention will be described with reference to exemplary embodiments illustrated in the figures, in which:

FIG. 1 is a simplified block diagram of an exemplary embodiment of the system 10 of the present invention; and

FIG. 2 is a flow chart of an exemplary embodiment of the method of the present invention.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention. Additionally, it should be understood that the invention can be implemented to enable any content owner to provide more control and accuracy to the time-shift recording of programs at a service provider network. Therefore, the term “programming network” should be construed to include not only conventional television programming networks, but also other content owners who may provide programs to service provider networks such as cable, satellite, or broadcast television providers.

A Push TSTV system in accordance with the present invention provides a mechanism for the programming network to provide more control and accuracy to the time-shift recording of programs. In this system, the programming network injects private metadata (such as CableLabs Asset Distribution Interface (ADI) 1.1 with enhancements) into the MPEG program stream to deliver scheduling and other recording information over the live broadcast stream. The MPEG private data are used by the TSTV system directly to schedule and record programs, including scheduling of last-minute changes.

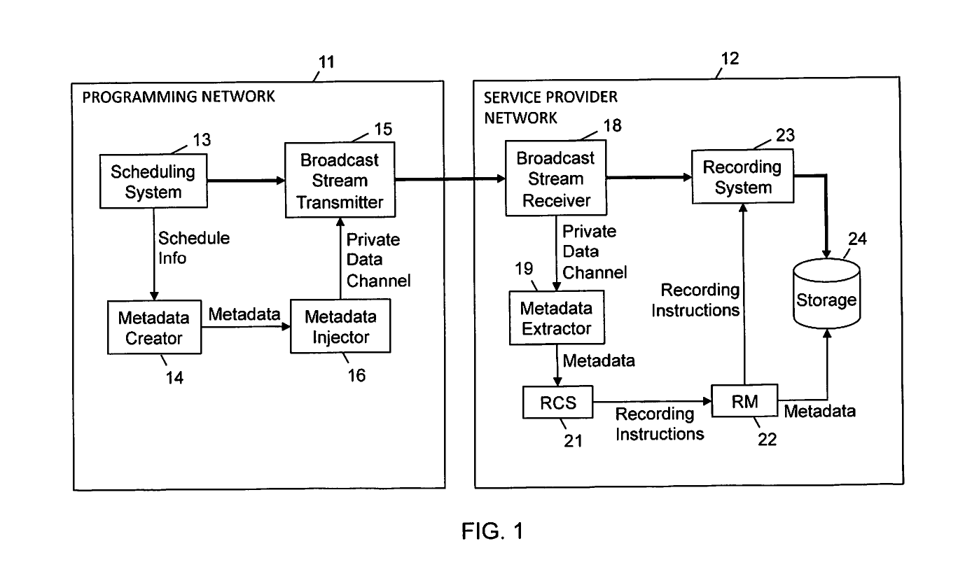

FIG. 1 is a simplified block diagram of an exemplary embodiment of the system 10 of the present invention. The system includes a Push TSTV system 11 at the programming network and a TSTV Recording system 12 at the service provider's network. The Push TSTV system includes a scheduling system 13 for providing scheduling information to a metadata creator 14 and a broadcast transmitter 15. The metadata creator creates the MPEG private data and provides it to a metadata injector 16. The metadata injector injects the MPEG private data into the broadcast stream 17 in a Private Data Channel at the broadcast transmitter. In one embodiment, the metadata replaces the conventional EPG scheduling information, and may include additional information such as recording rights or prohibitions for particular programs and advertising locations in the program (i.e., SCTE 130 ad insertion marks). In another embodiment, the metadata augments or modifies the EPG scheduling information rather than completely replacing it. In this embodiment, the metadata may include last minute scheduling changes, unusual program start or stop times, and the additional information relating to recording rights, advertising locations, and the like.

The TSTV Recording system 12 includes a broadcast receiver 18, a metadata extractor 19, a Recording Control System (RCS) 21, a Recording Manager (22), a recording system 23, and a storage memory 24 for storing recorded program files. The metadata extractor may be implemented as an Enhanced TV Binary Interchange Format (EBIF) application that is used by either a component in the head end, or by an end-user device. The broadcast receiver receives the broadcast stream 17 including the Private Data Channel. The metadata extractor accesses the Private Data Channel, extracts the metadata, and sends it to the RCS 21. Conventionally, the RCS reads the incoming schedules from an EPG, or other sources, and helps users set up the television programs they want to record. In the present invention, the RCS reads the metadata received from the programming network and uses it to replace or augment the EPG scheduling information. The RCS also enables the users to establish and control rights over what can and should be recorded according to agreements between content providers, programming networks, and service providers.

The RCS delivers recording instructions (for example, “program x on channel y”) to the RM 22 for active management of the recording system 23. The RM then instructs the recording system to start and stop recording at given times, on what channel, and the like. The recording instructions may also instruct the recording system to start recording or stop recording immediately. At the end of the recording, the RM may deliver the metadata for the recording to the end-user's system or to the storage memory 24.

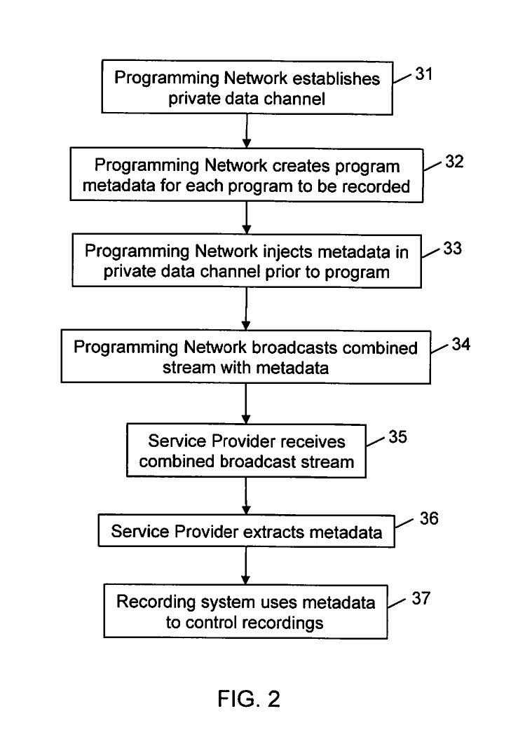

FIG. 2 is a flow chart of an exemplary embodiment of the method of the present invention. At step 31, the Programming Network 11 establishes a private data channel or other location for the delivery of metadata in the MPEG Broadcast feed. This may be done, for example, utilizing a separate Packet ID (PID) to identify the data stream. At step 32, the Programming Network creates programming metadata for each program to be recorded by the Push TSTV system. This metadata may be in a CableLabs ADI 1.1 format or any other format supported by the system. At step 33, the programming network injects the metadata into the private data channel of the MPEG Stream using the Metadata Injector 16. The metadata is normally inserted at a point in the broadcast stream prior to the program to be recorded so that it can be used by the TSTV system to make the recording. The required amount of time prior to the program that this data must be injected may vary according to the system requirements of the particular TSTV recording system. In some circumstances, the metadata may be updated later after the Service Provider Network 12 receives the program. Metadata updates associated with already recorded programs may be sent in the private data channel or in a separate private data channel. Multiple private data channels may be utilized to provide different recording instructions, metadata, or rights to different service providers. The Push-TSTV metadata may also include instructions for the manipulation of the content after recording. For example, the metadata may include other metadata required for the TSTV system, such as contract rights information, recording timings, and advertising locations in the program (i.e., SCTE 130 ad insertion marks). These markers may be used by the downstream system to remove the ads, replace the ads, or do other such manipulations as required by the Programming Network.

At step 34, the Programming Network 11 broadcasts the MPEG stream normally to the service provider 12. The private data channel is included in that stream. At step 35, the broadcast receiver 18 in the head end of the service provider receives the combined broadcast stream and directs the media stream to the recording system 23 and directs the private data channel to the metadata extractor 19. At step 36, the metadata extractor accesses the private data channel, extracts the metadata, and sends it to the RCS 21. The RCS creates recording instructions, which the RM 22 supplies to the recording system 23. At step 37, the recording system 23 uses the recording instructions to record programs in accordance with the scheduling information provided by the Programming Network. Timings of programs can be delivered so that they are frame accurate, allowing exact recording of the start and end of programs.

Some of the components at the Service Provider Network 12 may be operated either locally by the Service Provider or remotely by the Programming Network 11. The metadata included in the system may be augmented with other control instructions to give the Programming Network complete control over the TSTV recording system. Additionally, the components of the TSTV recording system may be located elsewhere than in the service provider's head end. For example, the components may be implemented in a home gateway, a customer set-top box, or other device not associated with the service provider.

In one embodiment, the system may also include a feedback loop to the Programming Network to provide confirmation of recordings and tracking of recording information.

In another embodiment, the metadata may be delivered out of band, through another connection such as, for example, the Internet.

As will be recognized by those skilled in the art, the innovative concepts described in the present application can be modified and varied over a wide range of applications. Accordingly, the scope of patented subject matter should not be limited to any of the specific exemplary teachings discussed above, but is instead defined by the following claims.

What is claimed is:

1. A method of enabling a television programming network to control recording of television programs by a service provider network, wherein the programming network transmits the television programs to the service provider network, and the service provider network records the television programs for time-shifted delivery to end users, the method comprising the steps of
sending recording instructions from the programming network to the service provider network; and
recording the television programs by the service provider network in accordance with the recording instructions.

2. The method according to claim 1, wherein the step of sending recording instructions includes:
injecting metadata by the programming network into a broadcast media stream to form a combined data stream, wherein the metadata includes the recording instructions; and
transmitting the combined data stream from the programming network to the service provider network.

3. The method according to claim 2, wherein the step of injecting metadata includes:
establishing by the programming network, a private data channel;
creating program metadata for each television program to be recorded; and
injecting the program metadata into the private data channel.

4. The method according to claim 3, wherein the step of establishing a private data channel includes utilizing a separate Packet ID (PID) to identify the metadata in the private data channel.

5. The method according to claim 3, wherein the step of creating program metadata includes creating metadata defining a scheduled start and stop time of each program.

6. The method according to claim 5, wherein the step of creating program metadata also includes creating metadata defining contract rights information and advertising locations in the program.

7. The method according to claim 3, wherein the step of injecting the program metadata into the private data channel includes injecting the metadata at a point in the broadcast media stream prior to the program to be recorded.

8. The method according to claim 3, wherein the step of injecting the program metadata into the private data channel includes injecting metadata updates in the broadcast media stream after the program to be recorded has been transmitted.

9. The method according to claim 1, wherein the step of recording the television programs includes the steps of:
receiving by the service provider network, a combined data stream from the programming network, wherein the combined data stream includes a broadcast media stream and metadata injected into the media stream by the programming network, the metadata including the recording instructions; and
extracting the metadata from the combined data stream to obtain the recording instructions.

10. The method according to claim 9, wherein the service provider network uses the recording instructions to replace all Electronic Program Guide (EPG) recording instructions.

11. The method according to claim 9, wherein the service provider network uses the recording instructions to replace only Electronic Program Guide (EPG) recording instructions that are incorrect due to changes to program schedules.

12. The method according to claim 1, wherein the step of sending recording instructions includes sending metadata by the programming network through a connection separate from a connection utilized to transmit the television programs to the service provider network.

13. The method according to claim 1, further comprising sending feedback information from the service provider network to the television programming network to provide confirmation of recordings and tracking of recording information.

14. An apparatus in a television programming network for controlling recording of television programs by at least one service provider network, wherein the programming network transmits the television programs to the service provider network, and the service provider network records the television programs for time-shifted delivery to end users, the apparatus comprising:
a scheduler for determining scheduling information for the television programs;
means for creating recording instructions based on the scheduling information; and
means for sending the recording instructions from the programming network to the service provider network.

15. The apparatus according to claim 14, wherein the means for sending the recording instructions includes:
means for injecting metadata into a broadcast media stream to form a combined data stream, wherein the metadata includes the recording instructions; and
means for transmitting the combined data stream to the service provider network.

16. The apparatus according to claim 15, wherein the means for injecting metadata includes:
means for creating program metadata for each television program to be recorded; and
means for injecting the program metadata into a private data channel.

17. The apparatus according to claim 16, wherein the private data channel is identified utilizing a Packet ID (PID) separate from the broadcast media stream.

18. The apparatus according to claim 16, wherein the means for creating program metadata includes means for creating metadata defining:
a scheduled start and stop time of each program;
contract rights information; and
advertising locations in the program.

19. The apparatus according to claim 18, wherein the means for creating program metadata includes means for creating different program metadata for each of a plurality of service provider networks.

20. An apparatus in a service provider network for recording television programs received from a television programming network, wherein the service provider network records the programs for time-shifted delivery to end users, the apparatus comprising:
means for receiving recording instructions from the television programming network; and
means for recording the television programs in accordance with the received recording instructions.

21. The apparatus according to claim 20, wherein the means for receiving recording instructions includes a receiver for receiving a combined data stream from the programming network, wherein the combined data stream includes a broadcast media stream and metadata injected into the media stream by the programming network, the metadata including the program instructions.

22. The apparatus according to claim 21, wherein the means for recording the television programs in accordance with the received recording instructions includes:
means for extracting the metadata from the combined data stream; and
means for determining the recording instructions from the extracted metadata.

23. The apparatus according to claim 20, wherein the apparatus is implemented in a head end at the service provider network.

24. The apparatus according to claim 20, wherein the apparatus is implemented in a set top box at an end-user's premises.

25. The apparatus according to claim 20, wherein the received recording instructions enable the television programming network to remotely control the apparatus.
